(19) United States
(12) Patent Application Publication
(10) Pub. No.: US 2014/0122084 A1
(43) Pub. Date: May 1, 2014

(54) Data Search Service

(71) Applicant: NUANCE COMMUNICATIONS, INC., Burlington, MA (US)

(72) Inventors: Alireza Salimi, Montreal (CA); Michael Leong, Montreal (CA); Chi Hang, Montreal (CA)

(73) Assignee: NUANCE COMMUNICATIONS, INC., Burlington, MA (US)

(21) Appl. No.: 13/660,483

(22) Filed: Oct. 25, 2012

(51) Int. Cl. G10L 15/18

(52) U.S. Cl. 704/275; 704/E15.018

(57) ABSTRACT

In an embodiment, speech may be acquired from a user. A concept, that may be associated with the user, may be identified from the acquired speech. The concept may be identified by fuzzy matching one or more words in the acquired speech with data contained in a data store. The data store may be associated with the user. An action may be performed based on the identified concept.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 illustrates a block diagram of an example embodiment of a system that may provide natural language understanding (NLU) services for multiple users;

FIG. 2 illustrates a block diagram of an example embodiment of a computing device;

FIG. 3 illustrates a block diagram of example components that may be contained at a service node;

FIG. 4 illustrates a block diagram of example components that may be contained at a runtime cluster component;

FIG. 5 illustrates a block diagram of example components that may be contained at a back end component of a service node;

FIG. 6 illustrates a flow diagram of example acts that may be used to process speech; and

FIG. 7 illustrates a flow diagram of example acts that may be used to identify a concept in speech.

### DETAILED DESCRIPTION

The following detailed description refers to the accompanying drawings. The same reference numbers in different drawings may identify the same or similar elements. Also, the following detailed description does not limit the invention.

Speech recognition may involve recognizing words that may be contained in speech. Natural language understanding (NLU) may involve establishing a comprehension of speech. For example, the sentence “Play mahjong.” includes the words “play” and “mahjong”. Speech recognition may be used to recognize these words in the sentence. NLU may be used to determine that these words may mean a command to play a game called “mahjong”.

A machine, such as a computing device, may employ speech recognition and NLU to enable a user to direct an operation of the machine using speech. For example, suppose that a computer game named “mahjong” is installed on a computing device and that a user of the computing device utters the words “play mahjong”. The computing device may use speech recognition to determine that the user has uttered the words “play” and “mahjong”. Further, the computing device may use NLU to determine that the uttered words mean that the user is directing the computing device to run the computer game named “mahjong” on the computing device. In response, the computing device may load the game into the computing device's memory and begin executing the game.

A service may be provided to support NLU for many users. The service may employ an architecture that may be capable of simultaneously providing NLU services for the users. The architecture may include, for example, multiple runtime components that may perform speech recognition, a load balancer that may distribute users among the runtime components, and a backend that may perform NLU of recognized speech.

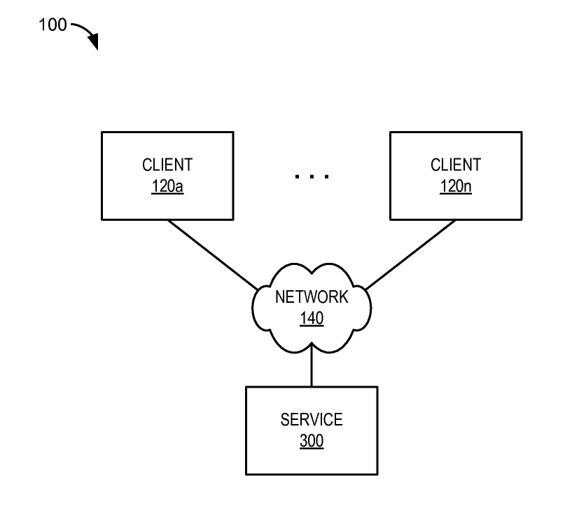

FIG. 1 illustrates a block diagram of an example embodiment of a system 100 that may provide NLU services for multiple users. Referring to FIG. 1, system 100 may include various components such as, for example, a plurality of client nodes 120a-n, a service node 300, and a network 140.

It should be noted that FIG. 1 illustrates an example embodiment of a system 100. Other embodiments of system 100 may include more components or fewer components than the components illustrated in FIG. 1. For example, other embodiments of system 100 may include multiple service nodes 300, multiple networks 140, and/or other components.

Also, functions performed by components in other embodiments of system 100 may be distributed among the components differently than as described herein. For example, one or more functions described herein that may be performed by service node 300 may be performed in other embodiments of system 100 in other nodes, such as, for example, a client node 120, across several client nodes 120, across several service nodes 300, and so on.

Network 140 may be a communications network that may enable information (e.g., data) to be exchanged between client nodes 120a-n and service node 300. The information may be exchanged using various communication protocols. The protocols may include, for example, the Internet Protocol (IP), Asynchronous Transfer Mode (ATM) protocol, Synchronous Optical Network (SONET) protocol, the Institute of Electrical and Electronics Engineers (IEEE) 802.11 protocol, the User Datagram Protocol (UDP), the Transmission Control Protocol (TCP), the Session Initiation Protocol (SIP), the Hypertext Transfer Protocol (HTTP), and/or some other protocol. The information may be contained in one or more data packets that may be formatted according to the various protocols. The packets may be unicast, multicast, and/or broadcast to/from client nodes 120a-n and service node 300.

Network 140 may include various network devices, such as, for example, gateways, routers, switches, firewalls, servers, repeaters, address translators, and/or other network devices. One or more portions of the network 140 may be wired (e.g., using wired conductors, optical fibers) and/or wireless (e.g., using free-space optical (FSO), radio frequency (RF), acoustic transmission paths). One or more portions of network 140 may include an open public network, such as the Internet. One or more portions of the network 140 may include a more restricted network, such as a private intranet, virtual private network (VPN), restricted public service network, and/or some other restricted network. One or more portions of network 140 may include a wide-area network (WAN), metropolitan area network (MAN), and/or a local area network (LAN). One or more portions of network 140 may be broadband, baseband, or some combination thereof. One or more portions of network 140 may be compliant with various telecommunications standards (e.g., International Mobile Telecommunications-2000 (IMT-2000), IMT-Advanced). Implementations of network 140 and/or devices operating in network 140 may not be limited with regards to, for example, information carried by the network 140, protocols used in the network 140, an architecture of the network 140, and/or a configuration of the network 140.

A client node 120 and service node 300 may include one or more computing devices that may perform functions provided by the client node 120 and service node 300, respectively. The computing devices may include, for example, a desktop computer, laptop computer, mainframe computer, blade server, personal digital assistant (PDA), netbook computer, tablet computer, web-enabled cellular telephone, smart phone, and/or some other computing device. For example, the client node 120 may include a mobile device, such as a tablet computer, and the service node 300 may include a fixed device, such as a mainframe computer.

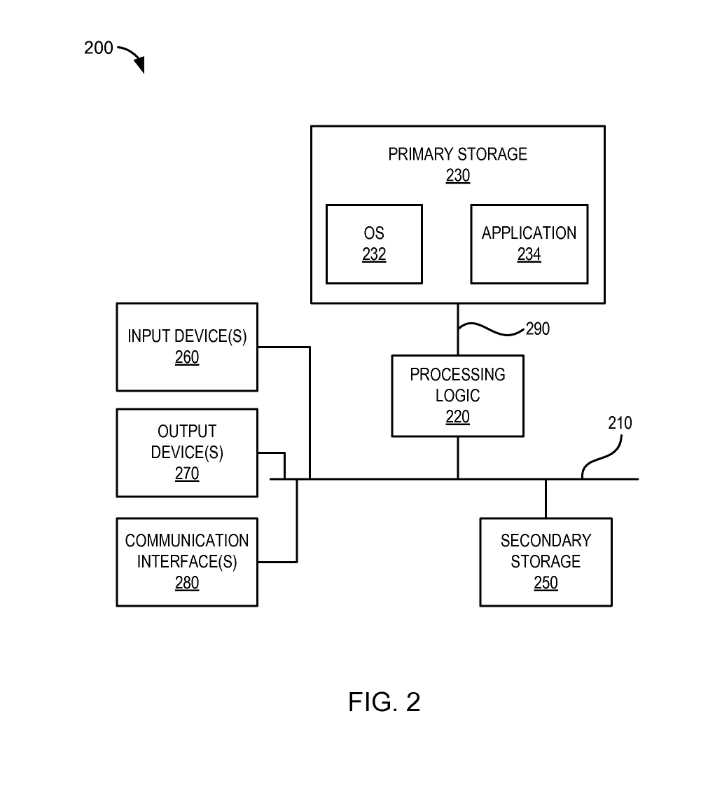

FIG. 2 illustrates a block diagram of an example embodiment of a computing device 200 that may be included in client node 120 and/or service node 300. Referring to FIG. 2, computing device 200 may include various components, such as, processing logic 220, primary storage 230, secondary storage 250, one or more input devices 260, one or more output devices 270, and one or more communication interfaces 280.

It should be noted that FIG. 2 illustrates an example embodiment of computing device 200. Other embodiments of computing device 200 may include more components or fewer components than the components illustrated in FIG. 2. Also, functions performed by various components contained in other embodiments of computing device 200 may be distributed among the components differently than as described herein.

Computing device 200 may also include an I/O bus 210 that may enable communication among components in computing device 200, such as, for example, processing logic 220, secondary storage 250, one or more input devices 260, one or more output devices 270, and one or more communication interfaces 280. The communication may include, among other things, transferring information (e.g., control information, data) between the components.

Computing device 200 may also include memory bus 290 that may enable information to be transferred between processing logic 220 and primary storage 230. The information may include instructions and/or data that may be executed, manipulated, and/or otherwise processed by processing logic 220. The information may be stored in primary storage 230.

Processing logic 220 may include logic for interpreting, executing, and/or otherwise processing information. The information may include information that may be stored in, for example, primary storage 230 and/or secondary storage 250. In addition, the information may include information that may be acquired by one or more input devices 260 and/or communication interfaces 280.

Processing logic 220 may include a variety of heterogeneous hardware. For example, the hardware may include some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), and/or other types of processing logic that may, for example, interpret, execute, manipulate, and/or otherwise process the information. Processing logic 220 may comprise a single core or multiple cores. An example of a processor that may be used to implement processing logic 220 is the Intel Xeon processor available from Intel Corporation, Santa Clara, Calif.

Secondary storage 250 may include storage that may be accessible to processing logic 220 via I/O bus 210. The storage may store information for processing logic 220. The information may be executed, interpreted, manipulated, and/or otherwise processed by processing logic 220. The information may include, for example, computer-executable instructions and/or data that may implement one or more embodiments of the invention.

Secondary storage 250 may include, for example, one or more storage devices that may store the information. The storage devices may include, for example, magnetic disk drives, optical disk drives, random-access memory (RAM) disk drives, flash drives, solid-state drives, and/or other storage devices. The information may be stored on one or more non-transitory tangible computer-readable media contained in the storage devices. Examples of non-transitory tangible computer-readable media that may be contained in the storage devices may include magnetic discs, optical discs, and/or memory devices. Examples of memory devices may include flash memory devices, static RAM (SRAM) devices, dynamic RAM (DRAM) devices, and/or other memory devices.

Input devices 260 may include one or more devices that may be used to input information into computing device 200. The devices may include, for example, a keyboard, computer mouse, microphone, camera, trackball, gyroscopic device (e.g., gyroscope), mini-mouse, touch pad, stylus, graphics tablet, touch screen, joystick (isotonic or isometric), pointing stick, accelerometer, palm mouse, foot mouse, puck, eyeball controlled device, finger mouse, light pen, light gun, neural device, eye tracking device, steering wheel, yoke, jog dial, space ball, directional pad, dance pad, soap mouse, haptic device, tactile device, neural device, multipoint input device, discrete pointing device, and/or some other input device. The information may include spatial (e.g., continuous, multi-dimensional) data that may be input into computing device 200 using, for example, a pointing device, such as a computer mouse. The information may also include other forms of data, such as, for example, text that may be input using a keyboard.

Output devices 270 may include one or more devices that may output information from computing device 200. The devices may include, for example, a cathode ray tube (CRT), plasma display device, light-emitting diode (LED) display device, liquid crystal display (LCD) device, vacuum florescent display (VFD) device, surface-conduction electron-emitter display (SED) device, field emission display (FED) device, haptic device, tactile device, printer, speaker, video projector, volumetric display device, plotter, touch screen, and/or some other output device. Output devices 270 may be directed by, for example, processing logic 220, to output the information from computing device 200. The information may be presented (e.g., displayed, printed) by output devices 270. The information may include, for example, text, graphical user interface (GUI) elements (e.g., windows, widgets, and/or other GUI elements), audio (e.g., music, sounds), and/or other information that may be presented by output devices 270.

Communication interfaces 280 may include logic for interfacing computing device 200 with, for example, one or more communication networks and enable computing device 200 to communicate with one or more entities coupled to the communication networks. For example, computing device 200 may include a communication interface 280 for interfacing computing device 200 to network 140. The communication interface 280 may enable computing device 200 to communicate with other nodes that may be coupled to network 140, such as, for example, service node 300 or a client node 120. Note that computing device 200 may include other communication interfaces 280 that may enable computing device 200 to communicate with nodes on other communications networks.

Communication interfaces 280 may include one or more transceiver-like mechanisms that may enable computing device 200 to communicate with entities (e.g., nodes) coupled to the communications networks. Examples of communication interfaces 280 may include a built-in network adapter, network interface card (NIC), Personal Computer Memory Card International Association (PCMCIA) network card, card bus network adapter, wireless network adapter, Universal Serial Bus (USB) network adapter, modem, and/or other device suitable for interfacing computing device 200 to a communications network.

Primary storage 230 may include one or more non-transitory tangible computer-readable media that may store, for example, computer-executable instructions and/or data. Primary storage 230 may be accessible to processing logic 220 via memory bus 290. The computer-executable instructions and/or data may implement operating system (OS) 132 and application 234. The computer-executable instructions may be executed, interpreted, and/or otherwise processed by processing logic 220.

Primary storage 230 may comprise a RAM that may include one or more RAM devices for storing the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, and/or other types of RAM devices.

OS 232 may be a conventional operating system that may implement various conventional operating system functions that may include, for example, (1) scheduling one or more portions of application 234 to run on (e.g., be executed by) the processing logic 220, (2) managing primary storage 230, and (3) controlling access to various components in computing device 200 (e.g., input devices 260, output devices 270, communication interfaces 280, secondary storage 250) and information received and/or transmitted by these components.

Examples of operating systems that may be used to implement OS 232 may include the Linux operating system, Microsoft Windows operating system, the Symbian operating system, Mac OS operating system, and the Android operating system. A distribution of the Linux operating system that may be used is Red Hat Linux available from Red Hat Corporation, Raleigh, N.C. Versions of the Microsoft Windows operating system that may be used include Microsoft Windows Mobile, Microsoft Windows 7, Microsoft Windows Vista, and Microsoft Windows XP operating systems available from Microsoft Inc., Redmond, Wash. The Symbian operating system is available from Accenture PLC, Dublin, Ireland. The Mac OS operating system is available from Apple, Inc., Cupertino, Calif. The Android operating system is available from Google, Inc., Menlo Park, Calif.

Application 234 may be a software application that may run under control of OS 232 on computing device 200. Application 234 and/or OS 232 may contain provisions for acquiring speech from a user, processing the acquired speech, performing an action based on the processed acquired speech and/or providing a result of the action to the user. These provisions may be implemented using data and/or computer-executable instructions.

Referring back to FIG. 1, service node 300 may provide a service to the client nodes 120a-n. The service may include NLU of speech. The speech may be acquired from one or more client nodes 120a-n. The service may be provided via a communication session that may be established between a client node 120 and the service node 300. The communication session may involve one or more communication protocols, such as the communication protocols described above.

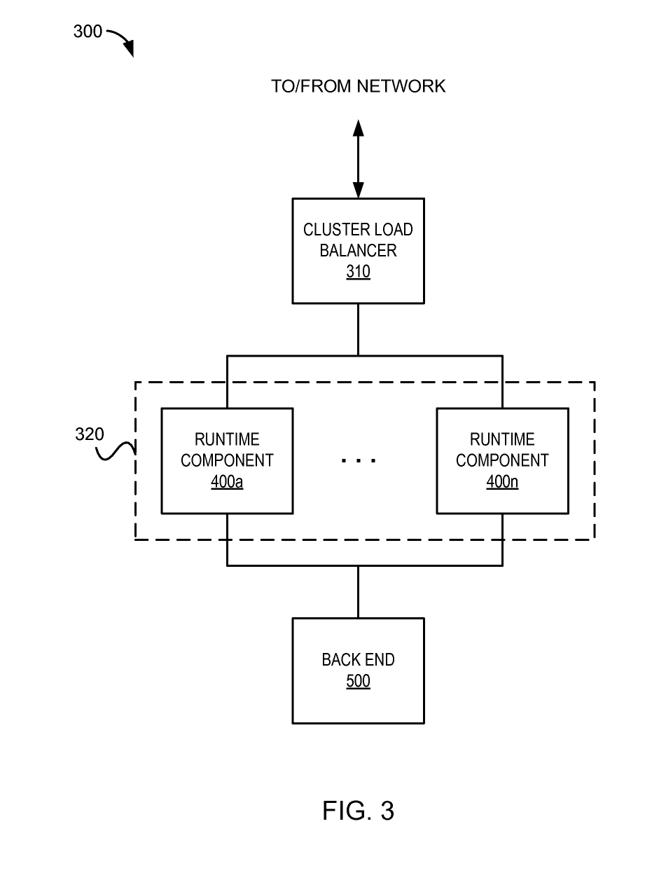

FIG. 3 illustrates a block diagram of an example embodiment of service node 300. Referring to FIG. 3, service node 300 may include a cluster load balancer 310, one or more runtime components 400a-n, and a back end 500. It should be noted that FIG. 3 illustrates an example embodiment of service node 300. Other embodiments of service node 300 may include more components or fewer components than the components illustrated in FIG. 3. Also, functions performed by various components contained in other embodiments of service node 300 may be distributed among the components differently than as described herein.

Cluster load balancer 310 may allocate resources, which may be provided by service node 300, to various client nodes 120. The resources may include resources provided by one or more runtime components 400 and/or back end 500. The resources may be allocated by the cluster load balancer 310 to the client nodes 120 based on various criteria.

For example, a client node 120 may be associated with an identifier (ID). The ID may be assigned to a user at the client node 120. The cluster load balancer 310 may use the ID to identify a runtime component 400 that may be used to service the client node 120 during a session that may be established between the client node 120 and service node 300. Note that criteria other than or in addition to an ID may be used by cluster load balancer 310 to identify resources, provided by service node 300, that may be allocated to a client node 120.

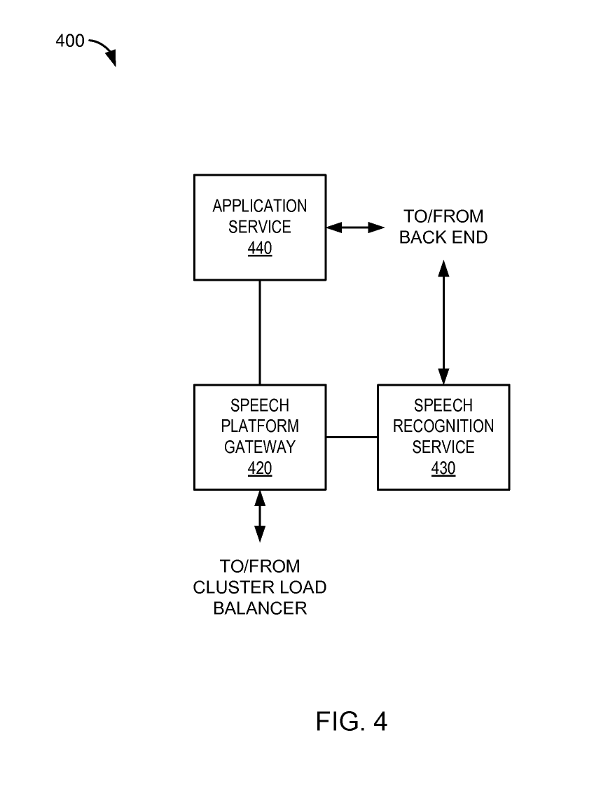

A runtime component 400 may provide various features to a client node 120. These features may include, for example, acquiring speech from the client node 120, performing speech recognition of the speech, and/or providing an application service for the client node 120. Details of features that may be provided by a runtime component 400 will be discussed further below with respect to FIG. 4.

One or more runtime components 400 may be organized as a cluster 320. A cluster 320 may be used to service, for example, a group of client nodes 120 and/or users at the client nodes 120. A service node 300 may contain multiple clusters 320 to service multiple groups of client nodes 120 and/or users at the client nodes 120.

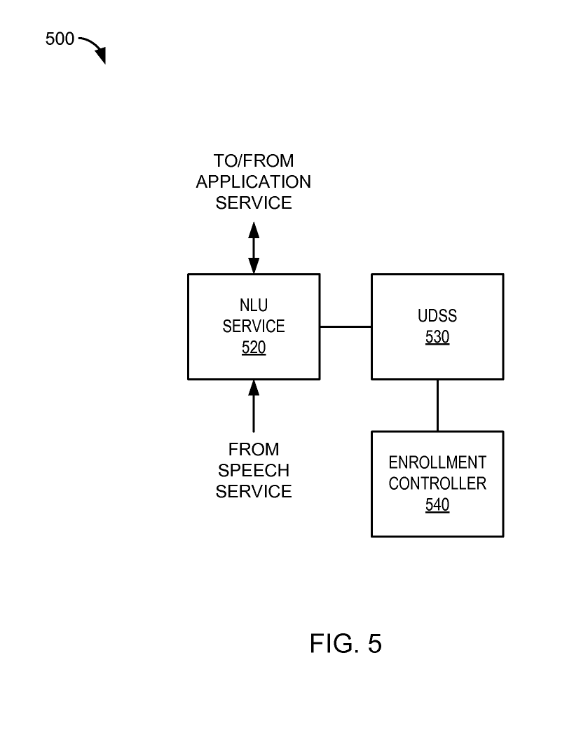

The back end 500 may provide various features associated with processing speech acquired by a runtime component 400. These features may include, for example, performing NLU and/or natural language processing (NLP) of acquired speech. Details of features that may be provided by back end 500 will be discussed further below with respect to FIG. 5.

It should be noted that features provided by service node 300 may be implemented using one or more computing devices, such as computing device 200. Computer-executable instructions and/or data that may implement these features may be included in data and/or computer-executable instructions that may be contained in, for example, OS 232 and/or application 234 of the computing devices, and/or may be stored in a secondary storage 250 associated with the computing devices.

FIG. 4 illustrates a block diagram of an example embodiment of a runtime component 400. Referring to FIG. 4, a runtime component 400 may include a speech platform gateway 420, a speech recognition service 430, and an application service 440.

The speech platform gateway 420 may provide a gateway service into a speech platform that may include speech recognition service 430, application service 440, and/or back end 500. The gateway service may provide various functions that may include, for example, interfacing the speech platform with a client node 120 and/or managing sessions between the speech platform and the client node 120.

The speech recognition service 430 may contain provisions for processing audio provided by a client node 120. The audio may be in, for example, an analog and/or digital form. The audio may include one or more words that may be recognized by speech recognition service 430. The words may be converted by the speech recognition service 430 into, for example, tokens, text, and/or some other form that may be recognized by the back end 500.

For example, the audio may be streamed from the client node 120 via the speech platform gateway 420 to the speech recognition service 430. The speech recognition service 430 may process the audio. Processing the audio may include speech recognition which may recognize one or more words contained in the audio. The words may be converted by the speech recognition service 430 into tokens and/or text that may be recognizable by the back end 500.

The application service 440 may provide, among other things, various applications to the client node 120. For example, a user may request a certain application (e.g., a game) be provided by service node 300. The request may be made by the user at a client node 120. The application service 440 may provide the requested application to the client node 120 via the speech platform gateway 420.

The application service 440 may also provide various dialogs to a user at a client node 120. The dialogs may be visual (e.g., a GUI dialog box) and/or audio (e.g., voice, tones). The dialogs may be requested by the back end 500. For example, the back end 500 may request that the application service 440 prompt the user for information. In response to the request, the application service 440 may direct the client node 120 to display a dialog box to acquire the information from the user. The application service 440 may acquire the information from the client node 120 and provide the information to the back end 500.

The application service 440 may also perform an action that may involve a client node 120. The action may be performed in response to a request from the back end 500. For example, as a result of processing speech provided by a user at a client node 120, the back end 500 may direct the application service 440 to stream audio to the client node 120. An application 234 at the client node 120 may process the streamed audio, which may include playing the audio to the user at the client node 120.

FIG. 5 illustrates a block diagram of an example embodiment of back end 500. Referring to FIG. 5, back end 500 may include an NLU service 520, a user data search service (UDSS) 530, and an enrollment controller (EC) 540.

The NLU service 520 may perform, among other things, NLU for service node 300. The NLU may include, for example, identifying one or more concepts in speech provided to the NLU service and performing an action based on the identified one or more concepts. The NLU service 520 may identify the concepts based on one or more results provided by the UDSS 530.

The UDSS 530 may provide a service that may include fuzzy matching data in a data store with one or more words contained in speech. One or more results of the fuzzy matching may be provided to the NLU service 520, which may use the results to identify one or more concepts in the speech. The fuzzy matching may be performed by an application 234 that may execute on one or more computing devices 200 that may be used to implement UDSS 530. The application 234 may be based on a search platform. An example of a search platform that may be used may include Apache Solr, which is available from the Apache Software Foundation.

The EC 540 may maintain data in the data store. The data may be maintained in, for example, a database, such as a relational database. The data may be associated with one or more users of a client node 120. The data may include, for example, user profile information, a description of information (e.g., applications, data) stored on the client node 120, and/or other information (e.g., personal contacts, business contacts, meeting schedules, event information, user preferences).

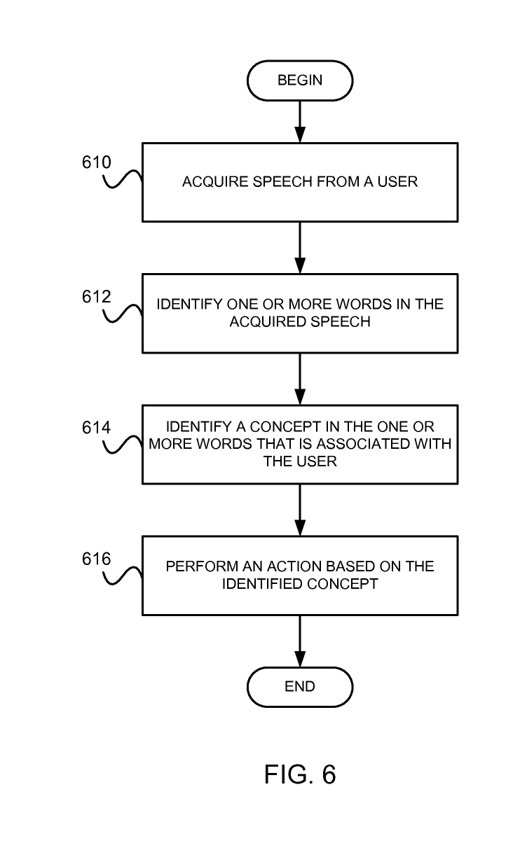

FIG. 6 illustrates a flow chart of example acts that may be used to process speech acquired from a user. Referring to FIG. 6, at block 610, speech may be acquired from the user. The speech may be acquired, for example, from a client node 120 associated with the user. Here, the user may utter the speech into a microphone that may be an input device 260 at the client node 120. The client device 120 may convert the speech from an audio form to a digital form and transfer the speech in the digital form via network 140 to service node 300. The speech may be transferred to service node 300 in, for example, data packets using various communication protocols, such as described above. At service node 300, the speech may be transferred by cluster load balancer 310 to a runtime component 400 that may be associated with the user. The runtime component 400 may acquire the speech at speech platform gateway 420 which may transfer the speech to speech recognition service 430.

At block 612, one or more words in the acquired speech may be identified. For example, after the speech is acquired by the speech recognition service 430, the speech recognition service 430 may use speech recognition to identify various words that may be contained in the speech. Speech recognition service 430 may convert the identified words into a form recognizable by the UDSS 530 (e.g., text, tokens). The converted identified words in the recognizable form may be transferred by the speech recognition service 430 to the UDSS 530.

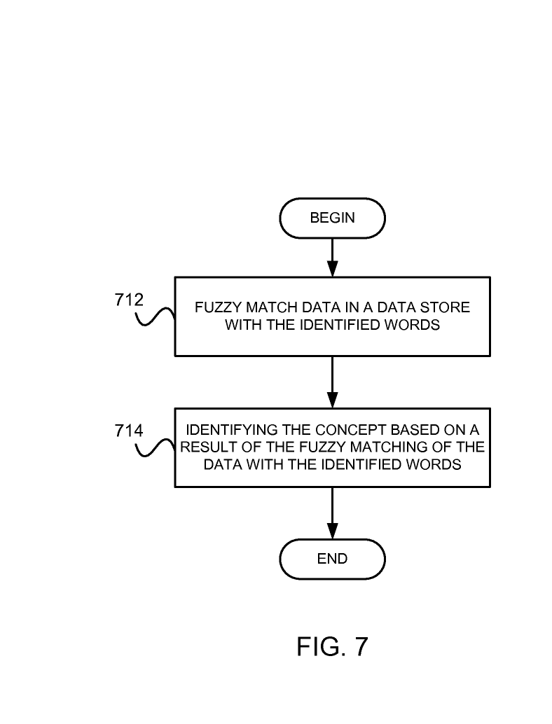

At block 614, a concept may be identified from the one or more words that were identified in the speech. The concept may be identified based on data associated with the user. Example acts that may be used to identify a concept in one or more words of speech will be discussed further below with respect to FIG. 7.

At block 616, an action may be based on the identified concept may be performed. For example, a concept that may be identified in the speech may relate to playing a particular song at the client node 120. An action that may be performed by service node 300 based on the identified concept may involve locating the song. After locating the song, other actions based on the identified concept may be performed by service node 300. For example, service node 300 may direct the client node 120 to start an application 234 to play the song. In addition, service node 300 may stream the song to the application 234 which plays the song at the client node 120.

FIG. 7 illustrates a flow diagram of example acts that may be used to identify a concept in speech. Referring to FIG. 7, at block 712 data in a data store may be fuzzy matched with one or more words identified in speech. The data in the data store may be associated with the user.

For example, the data may include a list containing data strings that may be maintained in a data store associated with a user of a client node 120. The list may be maintained by an EC 540. The data strings may represent names of musical compositions that the user often listens to at a client node 120. A UDSS 530 may request the data store from the EC 540. The EC 540 may provide (e.g., transfer) the data store including the list to the UDSS 530. The UDSS 530 may fuzzy match a string of one or more identified words in the acquired speech with one or more data strings contained in the list contained in the provided data store. For a particular data string in the list, a value (e.g., score, grade) may be generated that may represent a degree of matching between the data string in the list and the string of words in the identified acquired speech.

For example, suppose the words in the identified acquired speech include the string “Schubert's Unfinished Symphony” and that the list includes a first entry with the string “Schubert's Symphony No. 1”, a second entry with the string “Beethoven's Symphony No. 5”, and a third entry with the string “Shubert's Unfinished Symphony”. UDSS 530 may fuzzy match the string “Schubert's Unfinished Symphony” in the identified words with strings in the list and generate scores for entries in the list, where a score for the first entry indicates a close match, a score for the second entry indicates a poor match, and a score for the third entry indicates an exact match.

At block 714, the concept may be identified based on a result of the fuzzy matching of the data in the data store with the identified words. Continuing the above example, UDSS 530 may perform the fuzzy matching and generate the scores as a result of the fuzzy matching. UDSS 530 may provide (e.g., transfer) the scores to the NLU service 520. The NLU service 520 may use the scores to identify a concept in the speech. The concept identified by the NLU service 520 may include that the user has specifically requested that “Shubert's Unfinished Symphony” be played at the client node 120 and not some other musical composition.

The following example may be helpful in understanding the above. Suppose that a user is operating a client node 120 and utters the speech “play Beethoven's ninth symphony” into a microphone which is an input device 260 at the client node 120. The client node 120 may acquire the speech in an analog form and convert the analog form into a digital form. Processing logic 220 at the client node 120 may establish a communication session with service node 300 via network 140 to process the speech. The session may include a communications connection (e.g., a TCP connection) with the service node 300 that may enable data packets to be exchanged between the client node 120 and the service node 300. After establishing the session, processing logic 220 at the client node 120 may encapsulate the speech (now in digital form) in one or more data packets and transfer the data packets via a communication interface 280 at the client node 120 onto network 140. The data packets may travel through network 140 via the communications connection to service node 300.

The data packets may be acquired by a cluster load balancer 310 at service node 300. Specifically, a communication interface 280 in a computing device 200 that implements the cluster load balancer 310 may acquire the data packets from the network 140. Processing logic 220 in the computing device 200 may process the acquired packets. Processing may include forwarding the packets via the communication interface 280 to another computing device 200 at a runtime component 400, which may be associated with the user.

The packets may be received at a communication interface 280 of the computing device 200 that implements a speech platform gateway 420 at the runtime component 400. Processing logic 220 at the computing device 200 may process the packets. Processing may include extracting the speech from the packets and forwarding the speech via the communication interface 280 to another computing device 200 that may implement a speech recognition service 430 at the runtime component 400.

The computing device 200 that implements the speech recognition service 430 may acquire the speech via a communication interface 280. Processing logic 220 at the computing device 200 may perform speech recognition of the acquired speech. The speech recognition may include identifying one or more words in the acquired speech. The processing logic 220 may convert the one or more identified words into, for example, text and/or tokens that the processing logic 220 transfers to the back end 500 via the communication interface 280. Suppose the processing logic 220 converts the one or more identified words into text.

A computing device 200 that implements the NLU service 520 at the back end 500 may acquire the text via a communication interface 280 at the computing device 200. Processing logic 220 at the computing device 200 may process the text. Processing may include identifying a concept in the text. The concept may be associated with the user. Suppose that the text includes “play”, “beatoven's”, “ninth”, and “symphony”. In identifying the concept, the processing logic 220 may generate a request to fuzzy match the word “beatoven's”. The processing logic 220 may forward the request via the communications interface 280 to a computing device 200 that may implement UDSS 530.

A communications interface 280 at the computing device 200 that implements UDSS 530 may acquire the request. Processing logic 220 at the computing device 200 may process the request. Processing the request may include generating a request to search data a data store for words that begin with the letters “be”. The processing logic 220 may forward the request via the communications interface 280 to another computing device 200 that may implement EC 540.

A communications interface 280 at the computing device 200 that implements EC 540 may acquire the request. Processing logic 220 at the computing device 200 may process the request. Processing may include searching in a user specific data store (which may contain words that have specific meaning to the user) for words that begin with the letters “be”. The data store may be in a database (e.g., a relational database) that is maintained on a secondary storage 250 associated with the computing device 200. One or more words in the data store that begin with the letters “be” may be found as a result of performing the search. Suppose the words “Benjamin”, “Beethoven”, “Beatrice”, “Beaumont”, and “Belgium” are found in the data store during the search. The processing logic 220 may acquire the found words from the database and forward the found words via the communications interface 280 to the computing device 200 that implements the UDSS 530.

The communications interface 280 at the computing device 280 that implements UDSS 530 may acquire the found words. The processing logic 220 at the computing device 200 may process the found words. Processing may include performing a fuzzy matching of the word “beatoven's” to the found words. Processing may also involve generating a result of the fuzzy matching. The result may include a score that may represent a degree of matching between the word “beatoven's” and the found words. Note that a score is an example of a result of the fuzzy matching that may be generated. It should be noted that other results of the fuzzy matching may be generated. For example, a result of the fuzzy matching may include ranking and/or ordering the found words based on a degree of matching between the word “beatoven's” and the found words.

Suppose, for example, that scores for the found words are generated by the processing logic 220 and that the highest score is returned for the found word “Beethoven”. The processing logic 220 may provide the scores and the found words to the NLU service 520. Specifically, the processing logic 220 may transfer the scores and the found words via the communication interface 280 to the computing device 200 that implements the NLU service 520.

The communication interface 280 at the computing device 200 that implements the NLU service 520 may acquire the scores and the found words. The processing logic 220 at the computing device 200 may process the acquired scores and found words. Processing may include identifying that a concept in the speech is the composer “Beethoven”.

Processing may also include identifying other concepts associated with the speech. For example, the processing logic 220 may identify a concept that the user has made a request to play a musical composition and specifically “Beethoven's Ninth Symphony”. The processing logic 220 may utilize UDSS 530 to identify these concepts. For example, processing logic 220 may generate and issue a request to the UDSS 530 to fuzzy match the text “Beethoven's Ninth Symphony” to a list of names of musical compositions that are often requested by the user. Names in the list may be maintained in the user specific data store.

After identifying that the user has requested to play “Beethoven's Ninth Symphony”, the NLU service 520 may utilize the UDSS 530 to determine whether the musical composition is stored at the client node 120. For example, the EC 540 may maintain a description of information stored on the client node 120. The description of information may include a list of musical compositions stored at the client node 120. The UDSS 530 may acquire the list from the EC 540 and utilize fuzzy matching to determine whether “Beethoven's Ninth Symphony” is contained in the list of musical compositions. The UDSS 530 may provide results of the fuzzy matching (e.g., scores) to the NLU service 520.

The NLU service 520 may process the results to determine whether the musical composition is stored at the client node 120. Suppose based on the results the NLU service 520 determines that the musical composition is present at the client node 120. The NLU service 520 may take action based on the identified concept that the musical composition is present at the client node 120. Specifically, the NLU service 520 may issue a request to the client node 120 to play the musical composition at the client node 120. The NLU service 520 may indicate in the request where the musical composition is located. For example, the request may contain a path name of a file (e.g., MP3 file, WAV file) at the client node 120 that contains the musical composition. A result of the action may be the client node 120 playing the musical composition to the user. For example, the musical composition may be played by the client node 120 to the user through speakers (e.g., headphones, bookshelf speakers, car speakers). The musical composition may be played using an application that may run on the client node 120, such as a media player application.

Note that if the NLU service 520 were to determine that the musical composition was not present at the client node 120, the NLU service 520 may take an action that may include attempting to locate the musical composition elsewhere (e.g., at application service 440, a service in network 140). A result of the action may be successfully locating the musical composition. After successfully locating the musical composition, the NLU service 520 may, for example, stream the musical composition or direct another service to stream the musical composition to the client node 120.

The foregoing description of embodiments is intended to provide illustration and description, but is not intended to be exhaustive or to limit the invention to the precise form disclosed. Modifications and variations are possible in light of the above teachings or may be acquired from practice of the invention. For example, while a series of acts has been described above with respect to FIGS. 6 and 7, the order of the acts may be modified in other implementations. Further, non-dependent acts may be performed in parallel.

Also, the term “user”, as used herein, is intended to be broadly interpreted to include, for example, a computing device (e.g., fixed computing device, mobile computing device) or a user of a computing device, unless otherwise stated.

It will be apparent that one or more embodiments, described herein, may be implemented in many different forms of software and hardware. Software code and/or specialized hardware used to implement embodiments described herein is not limiting of the invention. Thus, the operation and behavior of embodiments were described without reference to the specific software code and/or specialized hardware—it being understood that one would be able to design software and/or hardware to implement the embodiments based on the description herein.

Further, certain features of the invention may be implemented using computer-executable instructions that may be executed by processing logic, such as processing logic 220. The computer-executable instructions may be stored on one or more non-transitory tangible computer-readable storage media. The media may be volatile or non-volatile and may include, for example, DRAM, SRAM, flash memories, removable disks, non-removable disks, and so on.

No element, act, or instruction used herein should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It is intended that the invention not be limited to the particular embodiments disclosed above, but that the invention will include any and all particular embodiments and equivalents falling within the scope of the following appended claims.

What is claimed is:

1. A method comprising:
acquiring speech from a user;
identifying a concept in the acquired speech, the identifying including:
fuzzy matching data in a data store associated with the user with one or more words contained in the speech, and
identifying the concept based on a result of the fuzzy matching of data in the data store with the one or more words; and
performing an action requested by the user in the acquired speech based on the identified concept.

2. The method of claim 1, further comprising:
identifying the one or more words contained in the speech.

3. The method of claim 2, wherein the one or more words are identified using speech recognition.

4. The method of claim 1, further comprising:
acquiring the data in the data store from a database.

5. The method of claim 1, wherein the data store includes a description of information stored on a computing device that is operated by the user.

6. The method of claim 4, wherein the computing device is a mobile device.

7. The method of claim 1, wherein the data in the data store associated with the user includes a data string and wherein identifying the concept in the acquired speech includes fuzzy matching the data string with the one or more words.

8. The method of claim 7, wherein the data string is contained in a list that is maintained in the data store associated with the user.

9. The method of claim 1, wherein the identified concept is associated with a score that represents a degree of match between data in the data store and the one or more words.

10. One or more computer readable mediums storing one or more executable instructions for execution by processing logic, the one or more executable instructions including:
one or more executable instructions for acquiring speech from a user;
one or more executable instructions for fuzzy matching data in a data store associated with the user with one or more words contained in the speech;
one or more executable instructions for identifying the concept based on a result of the fuzzy matching of data in the data store with the one or more words; and
one or more executable instructions for performing an action requested by the user in the acquired speech based on the identified concept.

11. The medium of claim 10, further storing:
one or more instructions for identifying the one or more words contained in the speech.

12. The medium of claim 10, further storing:
one or more instructions for acquiring the data in the data store from a database.

13. The medium of claim 10, wherein the data store includes a description of information stored on a computing device that is operated by the user.

14. The medium of claim 10, wherein the data in the data store associated with the user includes a data string and wherein identifying the concept in the acquired speech includes fuzzy matching the data string with the one or more words.

15. The medium of claim 14, wherein the data string is contained in a list that is maintained in the data store associated with the user.

16. The medium of claim 10, wherein the identified concept is associated with a score that represents a degree of match between data in the data store and the one or more words.

17. A system comprising:
processing logic for:
acquiring speech from a user,
identifying a concept in the acquired speech, the identifying including:
fuzzy matching data in a data store associated with the user with one or more words contained in the speech, and
identifying the concept based on a result of the fuzzy matching of data in the data store with the one or more words, and
performing an action requested by the user in the acquired speech based on the identified concept.

18. The system of claim 17, wherein the processing logic is further for:
identifying the one or more words contained in the speech.

18. The system of claim 17, wherein the processing logic is further for:
acquiring the data in the data store from a database.

20. The system of claim 17, wherein the data in the data store associated with the user includes a data string and wherein identifying the concept in the acquired speech includes fuzzy matching the data string with the one or more words.
